(19) United States
(12) Patent Application Publication
(10) Pub. No.: US 2024/0189944 A1
(43) Pub. Date: Jun. 13, 2024

(54) METHOD FOR PRODUCING A DECORATIVE PANEL HAVING IMPROVED STRUCTURING

(71) Applicant: AKZENTA PANEELE + PROFILE GMBH, Kaisersesch (DE)

(72) Inventors: Hans-Jürgen HANNIG, Bergisch Gladbach (DE); Felix HÜLLENKREMER, Koblenz (DE); Paul WEYER, Köln (DE)

(21) Appl. No.: 18/286,292

(22) PCT Filed: Apr. 14, 2022
(86) PCT No.: PCT/EP2022/060132

§ 371 Date: Oct. 10, 2023

(30) Foreign Application Priority Data
Apr. 19, 2021 (EP) 21169236.3

(51) Int. Cl. B23K 26/352; B23K 26/067

(52) U.S. Cl. CPC B23K 26/355; B23K 26/067

(57) ABSTRACT

The present disclosure relates to a method for producing a decorative panel, comprising the following method steps: a) applying a decorative layer to a substrate, b) optionally applying an intermediate layer to the decorative layer, c) applying a cover layer to the decorative layer or the intermediate layer, and d) structuring at least one layer to be structured, said layer to be structured being selected from the decorative layer, the intermediate layer and the cover layer, characterised in that method step d) comprises the following method steps: d1) generating a laser beam; d2) dividing the laser beam into a matrix of a plurality of sub-beams; d3) guiding the matrix of sub-beams into a modulator for selective inactivation of individual sub-beams; d4) guiding the matrix of sub-beams from the modulator into an optical scanner, the matrix of sub-beams downstream of the modulator comprising all the sub-beams guided into the modulator or a reduced number of sub-beams; and d5) guiding the matrix of sub-beams from the scanner onto the layer to be structured; d6) the layer to be structured being negatively structured under the action of the sub-beams in order to generate a three-dimensional structure.

### CROSS-REFERENCE TO RELATED APPLICATIONS

This application is a U.S. National Phase Application under 35 U.S.C. 371 of International Application No. PCT/EP2022/060132, filed on Apr. 14, 2022, which claims the benefit of European Patent Application No. 21169236.3, filed on Apr. 19, 2021. The entire disclosure of the aforementioned European Patent Application is incorporated herein by reference.

### FIELD

The present disclosure relates to a method for producing a decorative panel. In particular, the present disclosure relates to a method by which highly precise structures can be introduced into a panel layer by means of laser structuring in a simple and adaptable manner at a high throughput.

### BACKGROUND

This section provides background information related to the present disclosure which is not necessarily prior art.

In the course of producing a decorative panel, it may be desired to provide a layer of the corresponding layer structure with a structuring. This can be conventionally achieved, for example, by the action of a press plate, which is pressed onto the layer to be structured, in particular under the action of temperature and pressure.

However, it is also known to introduce structures into the layer to be structured by means of laser treatment.

DE 10 2005 046 264 A1 describes a method for producing a panel having a surface coating applied at least in sections, comprising the steps of:
applying an unprocessed pore layer
introducing pores into the pore layer by means of laser processing.

This document further relates to a panel whose surface is provided at least in sections with a pore layer into which pores are introduced by means of laser processing.

EP 3 685 979 A1 describes a method for producing floor panels, comprising the method steps:
producing a press plate provided with a relief,
forming the aforementioned floor plates, wherein the press plate is applied at least to realize embossed portions in the upper surface of a plate, from which subsequently floor plates are formed, wherein the relief in the press plate is realized by means of a laser treatment, and wherein the laser treatment is a material deposition process.

However, the aforementioned prior art may offer further potential for improvement, in particular with respect to the structuring of a decorative panel by means of laser treatment.

### SUMMARY

This section provides a general summary of the disclosure, and is not a comprehensive disclosure of its full scope or all of its features.

Thus, it is the object of the present disclosure to overcome at least one drawback of the prior art at least in part. In particular, the object of the present disclosure is to provide a solution by means of which laser structuring can be carried out in high resolution and with high throughput as a part of the production of a decorative panel.

Described is a method for producing a decorative panel, comprising the method steps:
a) applying a decorative layer onto a substrate;
b) optionally applying an intermediate layer onto the decorative layer;
c) applying a cover layer onto the decorative layer or the intermediate layer;
and
d) structuring at least one layer to be structured, wherein the layer to be structured is selected from the group consisting of the decorative layer, the intermediate layer and the cover layer,
wherein
method step d) comprises the method steps:
d1) generating a laser beam;
d2) splitting the laser beam into a matrix of a plurality of sub-beams;
d3) guiding the matrix of sub-beams into a modulator for selectively deactivating individual sub-beams;
d4) guiding the matrix of sub-beams from the modulator into an optical scanner, wherein the matrix of sub-beams downstream the modulator comprises all sub-beams guided into the modulator or a reduced number of sub-beams; and
d5) guiding the matrix of sub-beams from the scanner onto the layer to be structured, wherein
d6) the layer to be structured is negatively structured under the action of the sub-beams to produce a three-dimensional structure.

Such a method may have significant advantages over prior art solutions.

The method is used to produce a decorative panel. In the sense of the present disclosure, the term decorative panel is to be understood in particular as wall, ceiling, door or floor panels which have a decoration applied onto a carrier plate. Decorative panels are used in a variety of ways both in the field of interior construction of rooms and for decorative cladding of buildings, for example in exhibition stand construction. One of the most common applications of decorative panels is their use as floor covering, for covering ceilings, walls or doors. To this end, the decorative panels often have a decoration and a surface structure that is intended to imitate a natural material. It can also be advantageous if the haptically perceptible structure is adapted to the decoration, i.e. a so-called synchronous pore is present.

The method described here comprises the following method steps.

According to method step a), a decorative layer is applied onto a substrate. Thus, first a corresponding carrier can be provided.

The carrier used is not limited in itself. In principle, it may be preferred that the carrier is made of a plastic. Particularly preferably, the carrier may comprise a material comprising a plastic. Plastics which can be used in the production of corresponding panels or the carriers are, for example, thermoplastics such as polyvinyl chloride, polyolefins, for example polyethylene (PE), polypropylene (PP), polyamides (PA), polyurethanes (PU), polystyrene (PS), acrylonitrile butadiene styrene (ABS), polymethyl methacrylate (PMMA), polycarbonate (PC), polyethylene terephthalate (PET), polyether ether ketone (PEEK), or mixtures or co-polymers thereof. The plastics may contain common fillers, for example, calcium carbonate (chalk), aluminum oxide, silica gel, quartz flour, wood flour, gypsum. They may also be colored in a known manner. Preferably, the carrier may comprise talc as a filler material, for example in an amount, based on the total material of the carrier, of ≥30 wt.-% to ≤70 wt.-%, in particular from ≥40 wt.-% to ≤60 wt.-%. Furthermore, it may be provided that the carrier is multilaminar in structure, i.e. made of a plurality of films.

However, it is not excluded in the sense of the present disclosure that the carrier is wood-based, for example consists of wood, thus, for example, is an HDF or MDF carrier. Furthermore, the carrier can be, for example, a so-called WPC carrier, without leaving the scope of the disclosure.

Moreover, the application of the decorative layer is not limited in principle. In particular, however, the decoration is intended to imitate a decoration template. A “decoration template” can thus be understood in the sense of the present, in particular, as such an original natural material or at least a surface of such a material, which is to be imitated or simulated by the decoration.

The application of the decoration can, for example, be realized by applying the decoration directly onto the carrier, for example by means of a printing process, in particular a digital printing process. Furthermore, a suitable printing subsurface can be provided on the carrier. Alternatively, it is not excluded in the sense of the present disclosure that the decoration is applied in such a way that, for example, an already printed fiber layer, such as a paper layer, or also an already printed film, such as of polyethylene, polypropylene or polyvinyl chloride, is applied onto the carrier.

In the sense of the disclosure, the term fiber materials means materials such as paper and nonwovens based on plant, animal, mineral or even artificial fibers, as well as cardboards.

Furthermore, the fiber layer or film can be printed onto the carrier and thus serve as a printing subsurface, for example.

Furthermore, according to method step b), an intermediate, in particular a transparent, layer is optionally applied onto the decorative layer. Such an intermediate layer can also be selected in principle. For example, the intermediate layer can serve as a protective layer together with the subsequent cover layer. Another possibility is that the intermediate layer is a structural layer, i.e. can serve in particular to introduce the structure. As a non-limiting example, the intermediate layer may be, for example, a film, such as a plastic film, which is, for example, configured from polypropylene. With regard to a film made of polypropylene it has been shown that this is very well suited to be laser-based structured, even at high throughput, due to its physical and mechanical properties. In addition, there is the further advantage that comparatively few toxic vapors are produced during evaporation, for example in comparison with PVC.

In principle, the intermediate layer can be made of an elastomer, a thermoplastic, an aminoplast or a lacquer, for example. Examples of thermoplastics include polyvinyl chloride (PVC), polyolefins such as polyethylene (PE) or polypropylene (PP), polyethylene terephthalate, polyester, thermoplastic polyurethane (TPU), styrene or its derivatives (e.g. ASA, ABS). Examples of aminoplasts include, for example, urea and melamine formaldehyde resins or mixtures thereof. Examples of lacquers include, for example, acrylate-based lacquers, such as acrylate-based UV-curable lacquers, and/or aqueous lacquer systems.

Onto the intermediate layer or onto the decorative layer, an in particular transparent cover layer, is then applied in accordance with method step c). Such a layer for protecting the applied decoration can be applied in particular as a wear or cover layer above the decorative layer or the intermediate layer in a subsequent method step, which in particular protects the decorative layer from wear or damage caused by dirt, the influence of moisture or mechanical impacts such as abrasion. For example, it may be envisaged that the wear and/or cover layer is applied as a pre-produced overlay, for example based on melamine, onto the printed carrier and bonded to it by the action of pressure and/or heat. Furthermore, it may be preferred that moreover a radiation-curable composition, such as a radiation-curable lacquer, such as an acrylic lacquer, is applied to form the wear and/or cover layer. In this case, it may be provided that the wear layer includes hard materials such as titanium nitride, titanium carbide, silicon nitride, silicon carbide, boron carbide, tungsten carbide, tantalum carbide, aluminum oxide (corundum), zirconium oxide or mixtures thereof in order to increase the wear resistance of the layer. In this regard, the coating can be applied, for example, by means of rollers, such as rubber rollers, or by means of pouring devices.

Furthermore, the cover layer can be first partially cured and then a final coating with a urethane acrylate and a final curing, such as with a gallium emitter, can be carried out.

Furthermore, the cover and/or wear layer may include means for reducing the static (electrostatic) charging of the final laminate. For example, it may be provided to this end that the cover and/or wear layer comprises compounds such as choline chloride. In this context, the antistatic agent may be present, for example, in a concentration between ≥0.1 wt.-% and ≤40.0 wt.-%, preferably between ≥1.0 wt.-% and ≤30.0 wt.-%, in the cover and/or composition for forming the wear layer.

Likewise, a transparent wear layer, for example of thermoplastic polymers, may be suitable, which is applied, for example laminated, onto the decorative layer as a film, for example as a film web. If necessary, the use of an adhesion promoter/primer, that cross-links with the decorative layer by radiation curing from above (“adhesive lacquer”) or thermally seals (“hot melt”) is required for sufficient adhesion. A thermoplastic wear layer further offers advantages for the recycling process of the overall structure. A surface structuring can very easily be applied by heated structured sheets via a press or structured rolls via a calendar (these can also be synchronized with the decoration).

Furthermore, in the method described here, according to method step d) at least one layer to be structured is structured, wherein the layer to be structured is selected from the decorative layer, the intermediate layer and the cover layer. As already explained above, the structuring serves in particular to produce a haptically perceptible structure at the decorative panel and thus to give an impression as realistic as possible with regard to the original.

The structuring is basically carried out by use of a laser and is thus a so-called laser structuring. Laser structuring is carried out by use of the following method steps.

First of all, laser structuring is carried out in accordance with method step d1) by generating a laser beam. The type of generation of the laser beam can in principle be selected. In particular, however, the beam source and the generated laser beam or its parameters are selected depending on the material of the layer to be structured. Ideally, the material should be vaporized by the laser beam, so that the specific parameters should be set accordingly.

Furthermore, according to method step d2), the laser beam is divided into a matrix of a plurality of sub-beams. This step enables that the layer to be structured is not only structured by a single laser beam, but a structuring can take place simultaneously at a large number of positions. This effectively increases the throughput and thus the effectiveness of the method. The individual sub-beams can each be used to create structures separate from each other, or the laser beams can also process the same structure position successively or simultaneously. Simultaneous processing of the same structure position is possible, in particular in conjunction with multiple scanners and corresponding overlap of the scan fields.

In this respect, it should be noted that when the laser beam is divided, the power data are also reduced for each sub-beam with respect to the initial beam or, assuming ideal conditions, the sum of sub-beams has the same intensity as the initially generated laser beam. This shows that, in the case of desired deep structures, a plurality of sub-beams may be advantageous for processing, whereas in the case of structures with a comparatively shallow depth, fewer sub-beams or only one sub-beam may be sufficient.

In order to achieve the aforementioned advantages particularly effectively, it can be advantageous that method step d2) is carried out by dividing the laser beam into at least 250 sub-beams, for example into at least 500 sub-beams. This configuration enables a particularly defined structuring and also a particularly high effectiveness. Furthermore, such a division is possible by use of known means.

In this respect, it is further preferred if method step d2), i.e. dividing the laser beam into a matrix of a plurality of sub-beams, is carried out by use of a diffractive optical element (DOE). Such an element can be, for example, a glass element in a manner known per se, which has microstructures, in particular as a two-dimensional optical grating, which generate corresponding sub-beams from an initial beam by means of a diffraction pattern. Thus, the diffractive optical element is used as a beam splitter. As a further alternative, a so-called spatial light modulator (SLM) is in principle suitable for method step d2), wherein the present disclosure is in principle not limited to the examples mentioned.

For example, via two so-called relay lenses, often realized as a so-called 4f setup, the sub-beams are separated and coupled into the modulator as described below. Between the lenses there is a mask in the intermediate focus which filters out the unwanted higher diffraction orders.

According to the described method, as indicated above, it is provided that the sub-beams, i.e. the matrix of sub-beams, generated in method step d2), are subsequently fed into a modulator for selective deactivation of individual sub-beams. By use of such a modulator in the beam path of the laser beams, it is thus possible that individual sub-beams are deactivated and thus do not reach the layer to be structured or are removed from the beam path. As a result, the range of applications of the method can be further improved, or the quality and the adaptation of the structure to the template can be further improved. In particular, it may be possible that, depending on the structure to be produced, not all sub-beams are required, so that the method can also be used without any problems for such structures.

Furthermore, it may be particularly preferred to use an acousto-optical modulator (AOM) or an electro-optical modulator (EOM) as modulator. In particular, such modulators enable individual sub-beams to be removed at a high speed from the beam path leading to the surface to be structured.

A modulator is understood to mean an optical component that influences or modulates the frequency and propagation direction or intensity of incident light. For this purpose an optical grating is generated in an acousto-optical modulator in a transparent solid by use of sound waves. At this grating, the respective light beam or sub-beam is diffracted and simultaneously shifted in its frequency. The deflection of light in a prior art acousto-optical modulator works according to the principle of the diffraction of light at an optical grating. Correspondingly, in an electro-optical modulator, such as a crystal, the optical thickness is changed instantaneously as a function of the strength of an applied external electric field, thus allowing a deflection of individual sub-beams. Thus, a modulation of light based on electro-optical crystals takes place.

In particular in combination with an acousto-optical modulator or an electro-optical modulator as described above, it may further be preferred that a beam trap is used in combination with the modulator. This makes it possible to reliably deactivate the sub-beams removed from the beam path so that they do not hit on the surface to be structured and, furthermore, no negative influence or even danger emanates from them for the environment.

In the method described above, step d4) also involves directing the matrix of sub-beams from the modulator into an optical scanner, wherein the matrix of sub-beams downstream of the modulator comprises all sub-beams guided into the modulator or a reduced number of sub-beams. Thus, the matrix of sub-beams leaving the modulator, which thus comprises a corresponding pattern of sub-beams adapted to the structure to be applied, can be directed into the optical scanner. The optical scanner can then direct the corresponding sub-beams to the desired position of the layer to be produced, so that a corresponding structuring takes place. In this case, the optical scanner can direct all sub-beams onto the layer at the same time or, depending on the scanner, different sub-beams can be directed onto the layer to be structured independently of one another.

Thus, the optical scanner serves to direct the sub-beams to the correct position of the layer to be structured with positional accuracy and in dependence on the structure to be produced.

Particularly advantageously, at least one of a polygon scanner and a galvanometer scanner can be used as the optical scanner. For example, a polygon scanner or a galvanometer scanner or both a galvanometer scanner and a polygon scanner can thus be used, although of course also a plurality of galvanometer scanners and/or polygon scanners can be used.

Such scanners are particularly suitable for working with a high dynamic range and thus, in particular, for enabling a high throughput. Thus, in particular with the use of scanners, an industrial production of decorative panels can be enabled, in which an efficient production can be combined with a detailed structuring. In particular, the above-mentioned scanners are advantageously used to apply a very fine structure.

Galvanometer scanners are particularly suitable for applications in which large portions of the machining plane are not machined, thus resulting in time gains due to so-called “jumps” between the machining areas.

If, however, the entire surface is to be structured, polygon scanners are particularly suitable. By use of polygon scanners, a line-shaped machining process can be selected, wherein scanning speeds >1 km/s can be achieved. In this application, therefore, a combination of sub-beams switchable by modulators and a polygon scanner as a deflection unit seems to be particularly advantageous for maximizing the productivity. The sub-beams can be arranged in an array of any shape, for example square, rectangular, line-shaped.

Accordingly, according to method step d5), the matrix of sub-beams is directed from the scanner onto the layer to be structured, optionally via suitable focusing optics.

Due to the influence of the sub-beams, structuring now takes place by structuring the layer to be structured according to step d6) under the influence of the sub-beams or the sub-beam array in order to produce a three-dimensional structure by negative structuring. Negative structuring is understood to mean structuring in which a structure is introduced from the layer to be structured by selectively reducing the thickness of the corresponding layer, i.e. in the present case material is removed from the layer depending on the layer to be produced, in particular evaporated.

It should also be noted that the steps d2) to d6) described above preferably proceed in the numerical order, although the disclosure is not limited thereto. In addition, it is possible that further intermediate steps are inserted, or that the beams pass through further components between the mentioned components without leaving the scope of the disclosure. If it is thus described that the radiation is guided or proceeds from one component to a further component, this can comprise a direct or immediate guiding without further intermediate components as well as an indirect guiding with interposition of further components. It is likewise possible, however, that the structuring is carried out only with the method steps d1) to d6), so that the structuring consists of method steps d1) to d6).

The method described here has clear advantages over the methods known from the prior art.

In particular, the method described here can use laser structuring for structuring a decorative panel in such a way that a high throughput and thus an efficient method is possible while at the same time a very precise structuring is achieved. Thus, a particularly high quality of the haptically perceptible structure is enabled. This applies both to the haptic as such, which creates a very realistic impression, and to the design of the structure with reference to a template. Due to the individual method steps, in particular of the laser structuring, the template can be imitated up to the level of template identity, which can further improve the result of the structuring.

In addition, the method can be particularly effective in that it enables high throughput. This is because due to the individual method steps the structuring can be carried out very quickly while achieving a high quality of the structuring, so that the web speed of the semi-finished products to be structured for the production of the decorative panels can be very high. This applies likewise to a continuous feed as well as to a timed or sequential feed. Thus, synergetic effects of the combination of the individual method steps enable a structuring which can be used on a large scale and yet does not require any compromises in terms of quality and flexibility. The present disclosure thus relates in particular to a method by which by means of laser structuring highly precise structures can be introduced into a panel layer in a simple and adaptable manner at a high throughput.

Furthermore, it is possible to introduce the structures in a highly defined manner so that the layer to be structured, for example a lacquer layer, can be kept very thin. This can offer in particular advantages in terms of costs and weight.

Furthermore, the recyclability of the panels produced can also be improved in this way. In principle, there is also a high degree of flexibility with regard to the structuring, which offers significant advantages, in particular in combination with the application of the decoration by means of digital printing.

Preferably, in method step d6), the layer to be structured can be negatively structured under the action of the sub-beams to produce a three-dimensional structure in such a way that a material elevation resulting from material discharge, for example from a material ejection of molten material, is produced in the edge region of the introduced structure.

This method can produce a particularly realistic structure. This is because sharp edges at the surrounding of the inserted structure can be prevented in this way. Rather, a rounded edge can be produced by the material elevation, which introduces the structure haptically very similar to structures to be reproduced, such as wood structures.

Moreover, the material elevation makes it easier to represent deep structures because the perceived depth of the structure is not just the depth of the structure actually introduced, but just this depth in addition to the height of the material elevation. This makes it possible to create deep or deep-acting structures without the risk of damaging any decoration that may be present below the structure.

In detail, high-quality decorative panels often strive for a realistic reproduction of wood or stone structures, for example, with the greatest possible structure depth in the range of for example 30-250 μm, in particular 80-140 μm. The material elevation resulting from the structuring process results in an increase in the haptically and visually perceived structure depth in the layer to be structured, such as the cover layer of such products.

Depending on the process parameters, the material elevation is in the range of 1-100 μm, for example. As a result, the thickness of the layer to be structured can be reduced while maintaining the structure depth. This can offer the advantage that a higher transmission of the laser radiation can be accepted in the ablation process without damaging a decorative layer, if present, in order to generate more volume absorption, or that the use of less favorable lasers is made possible with respect to the optimum wavelength of the cover layer material to be processed.

Furthermore, a high variability of the method becomes possible. This is because it becomes possible to form the layer to be structured in the form of a film, for example. In this case, the film may be provided with a corresponding structure, for example, before lamination and printing. Furthermore, it is also possible to apply the structured film to an already printed carrier, to structure it on the carrier, and the film can also be printed from the back side. In principle, a so-called “reel-to-reel” process can also be used, in which the film is unwound from a reel, structured and stored on a reel until it is applied to a carrier. Alternatively, the film can also be applied to a carrier immediately after structuring, as indicated above.

To control the material discharge, it can be advantageous that at least one of the specific wavelength, the pulse energy, the pulse duration, the spot diameter, the repetition rate, i.e. the frequency of a pulsed laser, and the pulse overlap, i.e. the percentual overlap of single pulses in the scan direction, the laser radiation hitting on the layer to be structured, are selected based on the material of the layer to be structured.

In particular, these parameters can have an influence on the incoming intensity of the radiation and the heat accumulation in the material to be structured and thus directly determine the melt formation that occurs.

Exemplary parameters for generating a material elevation in transparent polypropylene as a layer to be structured are approximately the following.

Using a UV-UKP laser, the following parameters can be used:
wavelength: 343 nm
spot diameter: 50 μm
repetition rate: 100 KHz
pulse energy: 36 μJ
pulse length: 300 fs
pulse overlap: 80%
generated material elevation: 1 μm

Using an IR-UKP laser, the following parameters can be used:
wavelength: 1030 nm
spot diameter: 58 μm
repetition rate: 700 kHz
pulse energy: 70 μJ
pulse length: 800 fs
pulse overlap: 80%
generated material elevation: 2 μm

Using a CO₂ laser, the following parameters can be used:
wavelength=10.2 μm
spot diameter=250 μm
repetition rate=200 kHz
pulse energy: 500 μJ
pulse length: 2 μs
pulse overlap: 80%
generated material elevation: 30 μm

For example, the material elevation can be in a range of >0 to ≤100 μm, preferably in a range of ≥5 to ≤30 μm.

With regard to the formation of a material elevation, the following can be noted.

The ablation in the described structuring process is initiated by melting and vaporizing the material of the layer to be structured. The recoil of the evaporating molecules causes a partial ejection of the molten material, which settles at the edge of the structure as a material elevation. The resulting ablation morphology can, in other words, have in the height profile a material elevation in the edge region of the ablation crater caused by the molten material ejection. The expression of this material elevation is thereby largely determined by the proportion of melt-based to evaporation-based material discharge.

The ratio between the melt-based and the evaporation-based interaction zone of laser radiation and material can be adjusted in the process preferably via the wavelength, pulse energy and pulse duration as well as spot diameter, repetition rate and pulse overlap of the laser radiation impinging on the layer to be structured. The decisive factor here is the absorption behavior of the radiation in the material of the layer to be structured. While, for equal energy input, surface absorption maximizes the proportion of evaporation-based ablation, the proportion of melt-based ablation increases with increasing volume absorption due to the lower proportion of energy transferred into the material.

According to this principle, material-dependent laser radiation with a specific wavelength, pulse energy and pulse duration can be selected to set a desired ratio of melt- and evaporation-based material ablation. The aim here is, for example, to maximize material ejection in the edge region of the introduced structure without causing damages to a potentially present decorative layer underneath the layer to be structured due to an excessive transmission.

In principle, in addition to the use of only one laser beam source with a specific power, wavelength, beam profile and spot diameter, it is also possible to use several different beam sources with different power, wavelength, beam profile and spot diameter in combination. For example, the combination of a CO₂ laser with a power of 10 KW, a wavelength of 10.25 μm and a spot diameter of 250 μm and a UKP laser with a power of 1 kW, a wavelength of 343 nm and a spot diameter of 50 μm would be conceivable. This can have several advantages on the structuring process. Most of the required material removal could be carried out by a preceding CO₂ laser spot, whereas the subsequent UKP laser spot performs the fine processing for a higher structure resolution. Thus, a corresponding processing system can be designed more cost-effectively due to the different prices per output power depending on the laser. It would also be conceivable to only preheat the material via the CO₂ laser and remove material via the UKP laser. It would also be possible to use different beam profiles, e.g. a classic Gaussian beam profile for material removal and an annular beam profile or a so-called top-hat beam profile with a uniform intensity distribution for preheating the material. The corresponding beam profile can be generated either already in the beam source or via corresponding optical elements such as axicons, gratings or mirrors in the beam path.

In this embodiment, painting, which may take place after structuring, can particularly advantageous be carried out by preventing sharp edges. This is because the radii created by the material elevation allows an improved wetting of the surface during coating, as described in the following.

With regard to a coatability of the structured layer as described above, this can thus be influenced as follows. The ablation morphology created in the structured layer can lead to an improved coatability of the structured surface due to the proportion of the melt-based ablation. If the material is removed mainly via surface absorption of the radiation and thus via evaporation, a sharp-edged structure with small radii is produced in the upper and lower edge areas of the ablation crater. Due to the surface tension of paint systems, this can make wetting of the cover layer more difficult, in particular in the lower area of the ablation crater. If the material is also discharged via volume absorption and thus melt-based, the melt ejection already described results in a less sharp-edged structure with larger radii in the upper and lower areas of the ablation crater. This can favor the wetting during coating of the structured surface compared to predominantly evaporation-based structuring.

With regard to laser structuring, it may further be advantageous that method step d) is carried out by use of a laser selected from an ultra-short pulse laser, a CO₂ laser and an excimer laser. In particular by use of the laser sources described above, the method and in particular the described substeps of the laser structuring can be carried out effectively, so that a convincing result of the structuring is possible.

If an ultra-short pulse laser, also referred to as a UKP laser, is used in laser structuring, it may be preferred that method step d) is carried out in such a way by use of an ultra-short pulse laser, wherein a wavelength of the generated laser beam is in a range from ≥150 nm to ≤1070 nm, wherein the laser operates with a power in a range from ≥500 W to ≤100000 W, and wherein the laser beam has a beam diameter in the range from ≥10 μm to ≤500 μm. Using these parameters, it can preferably be achieved that the material of the layer to be structured is vaporized and thus the negative structuring can be reliably performed. In addition, very fine structures can also be generated with a high contrast, which makes the result of structuring appear particularly realistic.

It should be noted that, in principle and for all lasers used, the wavelength as well as the beam diameter apply equally to the generated initial beam as well as to the generated sub-beams. The power, on the other hand, is reduced from said power of the initial beam to the power of the sub-beams as a function of the number of sub-beams generated.

Particularly preferably, in method step d), the laser beam can be generated in a pulsed manner, wherein a pulse frequency in a range of ≤100 MHz and a pulse duration in a range of ≤1000 ns, approximately from ≥2100 fs to ≤1000 ns is used. This embodiment is particularly possible by use of an ultra-short pulse laser. Such a pulsed application of the laser beam enables, in particular, a thermal stress as low as possible on the layer to be structured or on the material of the layer to be structured. Thus, a particularly high surface quality of the structured layer is enabled.

Furthermore, in particular a combination of an ultra-short pulse laser at method step d1) and a polygon scanner as an optical scanner in method step d5) can offer particular advantages. This is because, for material removal with the lowest possible melt formation and the lowest possible thermal stress on the workpiece, the laser power required of UKP lasers is typically in a range of 50 W at maximum. In particular polygonal scanners offer a promising opportunity to exploit the increasing average laser power of UKP lasers for higher productivity. These allow high scanning speeds of >1 km/s on the workpiece in conjunction with high repetition rates. Dividing the laser beam into an array of sub-beams which is moved over the workpiece with a galvanometer scanner can also help here to reduce the thermal stress on the workpiece even at high power densities.

Further preferred and in particular as an alternative to the use of a UKP laser, method step d) can be carried out by use of a CO₂ laser, wherein a wavelength of the generated laser beam is in a range from ≥9.8 μm to ≤10.6 μm, wherein said laser operates at a power in the range from ≥500 W to ≤100000 W, wherein said laser beam has a beam diameter in the range from ≥150 μm to ≤1000 μm.

Such lasers are also advantageously suitable for the method described herein and are also available on the market in large numbers and in many variations. Thus, in particularly when using CO₂ lasers, a good adaptability to the desired specific application or to the desired result can be achieved.

As a further alternative, method step d) can be carried out by use of an excimer laser, wherein a wavelength of the generated laser beam is in a range from ≥100 nm to ≤380 nm, wherein the laser operates at a power which is in a range from ≥1000 W to ≤100000 W, wherein the laser beam has a beam diameter in a range from ≥150 μm to ≤1000 μm, such as up to ≤500 μm. Such lasers can also advantageously be operated in a pulsed mode, which can keep the thermal stress on the layer to be structured very low.

Preferably, prior to method step d5), the method comprises the further method step:
d7) guiding the laser beams through a scan objective, in particular through an f-Theta objective. The use of a scan objective, in particular an f-Theta objective, allows the laser beams or the laser to be positioned on a planar image field, i.e., the planar surface of the layer to be structured. In this case, the focus size can remain almost constant. Thus, by using a scan objective, a particularly defined structuring can be carried out, wherein furthermore particularly fine structures can be represented with high quality.

For example, in method step c), a film-like intermediate layer can be applied onto the decoration and the and the intermediate layer can be structured in method step d). The intermediate layer, such as the film-like intermediate layer, can in particular be formed from a plastic, such as polypropylene.

In principle, as already indicated above, it is possible to provide a relay lens package such as with two lenses at various points in the beam path. This allows the sub-beams to be spatially separated. This can provide opportunities to insert further components, such as a mask. Furthermore, the relay lens package can advantageously enable or improve a coupling into optical components, such as a modulator or a scanner. For example, the lens package can be implemented as a so-called 4f setup, where 4f refers to the arrangement of the modules and the spacing between them and f stands for the focal length of the lenses.

### DRAWINGS

The drawing described herein is for illustrative purposes only of selected embodiment(s) and not all possible implementations, and are not intended to limit the scope of the present disclosure.

The disclosure is explained in more detail below with reference to a figure.

FIG. 1 schematically shows an implementation of the method according to the disclosure.

Corresponding reference numerals indicate corresponding parts throughout the view of the drawing.

### DETAILED DESCRIPTION

Example embodiment(s) will now be described more fully with reference to the accompanying drawing.

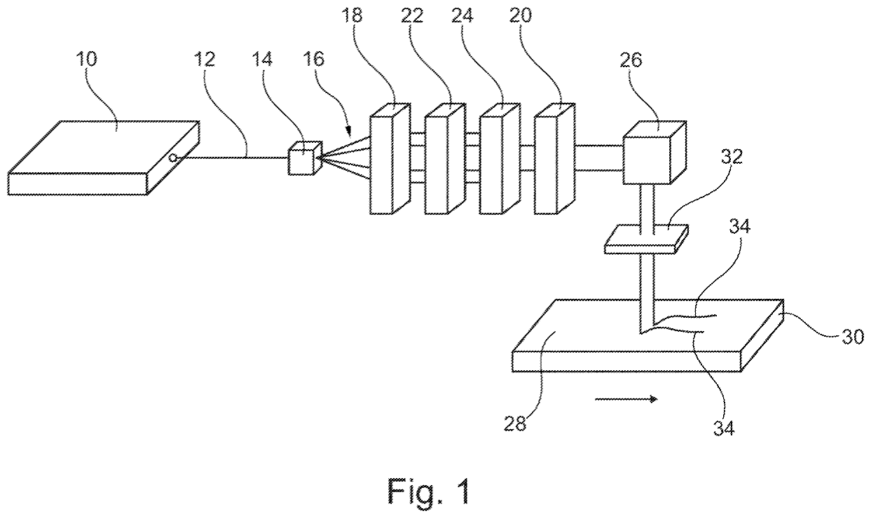

In FIG. 1 the implementation of the method according to the disclosure is shown.

In detail, FIG. 1 first shows a beam source 10 which generates a laser beam 12. The beam source 10 in the configuration according to FIG. 1 is an ultra-short pulse laser, wherein the wavelength of the generated laser radiation lies in a range from ≥150 nm to ≤1070 nm. Furthermore, the beam source 10 operates with a power in a range from ≥500 W to ≤100000 W, and wherein the laser beam 12 has a beam diameter in a range from ≥10 μm to ≤500 μm. Further, the laser beam 12 is generated in a pulsed manner by use of a pulse frequency in a range of ≤100 MHz and a pulse duration in a range from ≥100 fs to ≤1000 ns.

The generated laser beam 12 now impinges on a diffractive optical element 14, in which a division of the laser beam 12 into a matrix 16 of a plurality of sub-beams takes place. For example, the laser beam can be divided into more than 250 sub-beams or far more. Depending on the design of the diffractive optical element 14, an incoming laser beam 12 can thus be divided into a desired number of principal diffraction orders and thus sub-beams.

The sub-beams can be coupled into the deflection unit and spatially separated via a relay lens package, for example with two lenses 18, 20, often realized as a so-called 4f setup. Furthermore, a mask 22 is provided between the lenses 18, 20 in the intermediate focus, which can filter out the unwanted higher diffraction orders. Behind the mask 22 and in front of the second lens 20, moreover, a so-called acousto-optical multi-channel modulator (AOMC) is provided as an example of an acousto-optical modulator (AOM) or modulator 24. In an AOM, switching by sound waves in a transparent solid creates an optical grating that diffracts and deflects the sub-beams, usually into a beam trap. This serves to selectively deactivate individual sub-beams.

In this case, it is in principle possible to use a plurality of individual AOMs in order to process the matrix 16 of sub-beams completely by a modulator 24 and to be able to modulate or switch the sub-beams individually. In contrast, multi-channel AOMs allow the modulation of multiple individual sub-beams. In principle, a plurality of modulators 24 or one or more multi-channel modulators 24 can be used.

FIG. 1 schematically shows that behind the modulator 24 a reduced number of sub-beams are present in the matrix 16 and these are now directed into an optical scanner 26 as a deflection unit. By means of the scanner 26, the sub-beams can be directed at high speed onto a surface or a layer 28 to be structured of a semi-finished product 30 for a decorative panel. The optical scanner 26 is in particular a polygon scanner.

More precisely, after exiting the scanner 26, the sub-beams can be focused by an f-Theta objective 32 onto the workpiece or the layer 28 to be structured. f-Theta objectives are used in particular because, on the one hand, they keep the laser spot in focus when the radiation is deflected on the workpiece and, on the other hand, they can partially compensate distortions of the scan field that occur in mirror-based 2D scanning systems and thus enable constant scanning speeds on the workpiece.

In principle and independent of the specific design, the following should be mentioned. In addition to distortions by means of the deflection system and the focusing optics, the diffractive optical element 14 can already cause distortions in the working plane, which can increase due to an increasing distance between the sub-beams as well as with an increasing number of beams in the matrix 16. Besides optical compensation approaches, such as the f-Theta objective 32, this problem can be circumvented by creating a software-based, scanner-based correction of the scan vectors for each individual sub-beam. However, an additional compensation of the distortion by any optical components, such as the f-Theta objective 32, may still be possible as an alternative or in addition.

FIG. 1 further shows schematically that the layer 28 to be structured is negatively structured under the action of the matrix 16 at sub-beams for producing a three-dimensional structure 34. In this case, the layer 28 to be structured can be a film, for example made of polypropylene, which is applied onto a decorative layer. Furthermore, it is possible that a material elevation resulting from material discharge 20 is produced in the edge region of the introduced structure 34.

Following the structuring shown, optionally a cover layer can still be applied onto the structured layer in order to produce the finished decorative panel.

Furthermore, circumferential interlocking means can be introduced, which can allow interlocking of the panel with other panels, for example for producing a floor covering, for example.

An exemplary embodiment for structuring may be possible as follows.

For a processing of panels with dimensions of 1300×1280 mm, the following setup would be possible as an example. A total of nine polygon scanners with a scan field size of 450 mm²×450 mm², and a spot size of the sub-beams of 50 μm can be used. Furthermore, a pulse overlap of the respective pulses generated by the scanners of 50% can be achieved. Furthermore, a number of ablation layers of 160 can be used, so that for a structure depth of 80 μm 0.5 μm of ablation per layer or per processing takes place.

The processing time per panel can be 2.229 s per panel, for example at a panel feed rate of 35 m/min.

Furthermore, 740 switchable sub-beams 45 watts (fluence 0.08 J/cm²) each can be processed per scanner 26, which are divided and arranged in lines by means of a DOE 14 and are switchable by corresponding AOMs. The distance between each sub-beam impinging on the panel can be about 600 μm.

With this embodiment, a processing speed of the polygon scanners can be 717 m/s and the required laser power can be 300 KW and the required repetition rate or frequency of the UKP laser can be 28.68 MHz. The pulse length can be <10 ps preferably <1 ps.

With the above mentioned values, i.e. panel size and processing parameters of the panels, a vector length per panel, i.e. the total length of laser processing lines caused by all processing operations, calculated from the length of the lines per panel×number of processed layers, of 10649600 m can be present.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of producing a decorative panel, comprising the steps of:
a) applying a decorative layer onto a carrier;
b) optionally applying an intermediate layer onto the decorative layer;
c) applying a cover layer onto the decorative layer or the intermediate layer; and
d) structuring at least one layer to be structured, wherein the layer to be structured is selected from the group consisting of the decorative layer, the intermediate layer and the cover layer,
characterized in that
method step d) comprises the method steps:
d1) generating a laser beam;
d2) dividing the laser beam into a matrix of a plurality of sub-beams;
d3) directing the matrix of sub-beams into a modulator for selectively deactivating individual sub-beams;
d4) directing the array of sub-beams from the modulator into an optical scanner, wherein the matrix of sub-beams behind the modulator comprises all of the sub-beams directed into the modulator or a reduced number of sub-beams directed into the modulator; and
d5) guiding the matrix of sub-beams from the scanner onto the layer to be structured; wherein
d6) the layer to be structured is negatively structured under the action of the sub-beams to produce a three-dimensional structure.

2. The method according to claim 1, wherein in method step d6) the layer to be structured is negatively structured under the action of the sub-beams for producing a three-dimensional structure in such a way that a material elevation resulting from material discharge is produced in the edge region of the introduced structure.

3. The method according to claim 2, wherein for controlling the material discharge at least one of the specific wavelength, the pulse energy, the pulse duration, the spot diameter, the repetition rate, and the pulse overlap of the laser radiation impinging on the layer to be structured are selected based on the material of the layer to be structured.

4. The method according to claim 1, wherein the modulator is used in combination with at least one beam trap.

5. The method according to claim 1, wherein method step d2) is carried out with dividing of the laser beam into at least 250 sub-beams.

6. The method according to claim 1, wherein as optical scanner at least one of a polygon scanner and a galvanometer scanner is used.

7. The method according to claim 1, wherein method step d) is carried out by use of an ultra-short pulse laser, wherein a wavelength of the generated laser beam is in a range from ≥150 nm to ≤1070 nm, wherein the laser operates at a power in a range from ≥500 W to ≤100000 W, and wherein the laser beam has a beam diameter in a range from ≥10 μm to ≤500 μm.

8. The method according to claim 7, wherein in method step d) the laser beam is generated in a pulsed manner, wherein a pulse frequency in a range from ≥100 MHz and a pulse duration in a range from ≥100 fs to ≤1000 ns is used.

9. The method according to claim 7, wherein in method step d1) an ultra-short pulse laser is used as beam source and in method step d5) a polygon scanner is used as optical scanner.

10. The method according to claim 1, wherein method step d) is carried out by use of a CO₂ laser, wherein a wavelength of the generated laser beam is in a range from ≥9.8 μm to ≤10.6 μm, wherein the laser operates at a power in a range from ≥500 W to ≤100000 W, wherein the laser beam has a beam diameter in a range from ≥150 μm to ≤1000 μm

11. The method according to claim 1, wherein method step d) is performed by use of an excimer laser, wherein a wavelength of the generated laser beam is in a range from ≥100 nm to ≤380 nm, wherein the laser operates at a power in a range from ≥1000 W to ≤100000 W, wherein the laser beam has a beam diameter in a range from ≥10 μm to ≤1000 μm.

12. The method according to claim 1, wherein the method comprises prior to method step d5) the further method step of: d7) directing the matrix of sub-beams through a scan objective, in particular through an f-Theta objective.

13. The method according to claim 1, wherein the laser beam is divided in method step d2) by a diffractive optical element into a plurality of sub-beams.

14. The method according to claim 1, wherein in method step c) a film-like intermediate layer is applied onto the decoration and the intermediate layer is structured in method step d).

15. The method according to claim 14, wherein the intermediate layer is formed from a thermoplastic, an aminoplast or a lacquer.
